(19) United States
(12) Patent Application Publication
(10) Pub. No.: US 2026/0177677 A1
(43) Pub. Date: Jun. 25, 2026

(54) OUTDOOR LAMP APPLICATION METHOD BASED ON TOF TECHNOLOGY

(71) Applicant: Ningbo Zhiding Electric Appliance Co., Ltd., Ningbo (CN)

(72) Inventor: Hongyong He, Ningbo (CN)

(21) Appl. No.: 19/000,537

(22) Filed: Dec. 23, 2024

(30) Foreign Application Priority Data
Oct. 22, 2024 (CN) 2024114787124

(51) Int. Cl. G01S 7/4865; G01S 7/481; G01S 7/4863; G01S 17/89; H05B 45/10; H05B 45/325; H05B 47/105; H05B 47/17

(52) U.S. Cl. CPC G01S 7/4866; G01S 7/4813; G01S 7/4863; G01S 17/89; H05B 45/10; H05B 45/325; H05B 47/105; H05B 47/17

(57) ABSTRACT

An outdoor lamp application method based on TOF technology, comprising the following steps: S1 design a TOF sensor module; S2 determine electronic components; S3 write a timer program; S4 set a distance threshold; S5 realize light adjustment function; S6 add multiple modes selection; S7 conduct environmental adaptability tests. The invention not only improves responsiveness of lamps under different environmental conditions through precise distance measurement and intelligent control, but also effectively prevents fire and other safety hazards. At the same time, the technology can realize dynamic adjustment of lights, automatically adjusting brightness according to the distance of the target object, thus improving the user experience, solving the problem that the application solution of the phototriode principle cannot make a judgment on the black objects, and application of infrared emission principle is greatly affected by ambient light and the light source itself, not being able to make judgment.

### 1. TECHNICAL FIELD

The invention belongs to the technical field of lighting equipment, specifically relates to an outdoor lamp application method based on TOF technology.

### 2. BACKGROUND ART

Outdoor lamps, with compact size, easy to carry, are often used in our daily life, but the existing lamps in the use have the following shortcomings:

The common lamps on the market have a fixed structure, single function, and cannot control the brightness of light according to the application scene, as users pursue the brighter brightness of the lamps, thus causing the corresponding security problems. Some lamps have processed through the infrared emission principle or the application of phototriode principle, but it can not completely solve the problem and is unable to meet the user's needs, due to low applicability and safety issues in use.

TOF (time of flight) technology and outdoor lamps are combined to solve the problem that the objects close to lamps are not restricted when lamps close to the person or objects, as lamps equipped with internal TOF module can do the corresponding setting judgment, but also solved the problem that the application solution of the phototriode principle can not make a judgment on the black objects, and application of infrared emission principle is greatly affected by ambient light and the light source itself, not being able to make judgment.

### 3. SUMMARY OF THE INVENTION

To address the deficiencies of the prior art, the invention provides an outdoor lamp application method based on TOF technology to solve the problems raised in the above background art.

In order to realize the above purpose, the invention provides the following technical solution: an outdoor lamp application method based on TOF technology, comprising the following steps:
S1 design a TOF sensor module;
selecting a TOF sensor module suitable for an outdoor environment, the module comprising an emitter and a detector to ensure that reflected signals can be accurately received under various lighting conditions, such as strong sunlight or at night;
S2 determine electronic components;
after selecting the sensor, determine other electronic components required, such as microcontroller (MCU), timer, and lighting drive circuit;
S3 write a timer program;
using a timer function in the microcontroller, write a program to control pulse emission and reception of the TOF sensor module, after the transmitter sends out a pulse, the program needs to start the timer to record the time of pulse emission, and the timer stops when the detector receives a return pulse, at this time, distance of a target object is deduced by calculating the time difference, i.e. the round-trip time of the pulse, which is the lighting distance of the outdoor lamp and the target object;
S4 set a distance threshold;
according to different application scenarios of the lamps, different distance thresholds are set, which are used to realize automatic control of the lamps;
S5 realize light adjustment function;
implement the light intensity adjustment function in the program, and control the brightness of the lamp through PWM (pulse width modulation) technology;
S6 add multiple modes selection;
design a variety of working modes for the lamp, such as constant light mode, sensing mode and timer mode, and the user selects the appropriate working mode according to different scenes;
S7 conduct environmental adaptability tests;
ensure that the lamp can work properly in various environments, and conduct a series of environmental adaptability tests.

Further optimizing the present technical solution, in said step S1, the emitter in the TOF sensor module is responsible for emitting pulsed light of a specific frequency, while the receiver is used to receive the pulsed light reflected back;

The TOF sensor module is designed to be well waterproof and shock-resistant for adapting to the harsh conditions of the outdoor environment.

Further optimizing the present technical solution, in said step S3, square wave pulse is used to construct the pulse modulation scheme based on the pulse modulation method of the square wave pulse by directly calculating the time difference between the pulse transmission and reception through a timer, and then finding the distance of the target object.

Further optimizing the present technical solution, in said step S3, constructing the pulse modulation scheme based on the pulse modulation method of square wave pulse comprises the following process:
a square wave modulated irradiated light source is used to realize pulse modulation in a digital circuit, the detector adopts an array optical detector, and the emitter adopts an array laser;
each pixel of the array optical detector consists of a unit that converts an incident light into a current-sensitive light, connected to 2 switches controlled by a mediation module, the switches are designed as G0 and G1, which introduce the current into different capacitors storing charges, the capacitors are designed as C1 and C2;
in the process of distance measurement, when the array laser emits optical pulses at the same time, a high-frequency switch is tuned to G1, a photosensitive element is connected to the C1 capacitor, generating a pulse window in phase A, and the C1 capacitor begins to receive charges;
after an optical pulse is emitted, the switch is tuned to G0, the photosensitive element is connected to the C2 capacitor, and generating another pulse window in delayed phase B, and the C2 capacitor begins to receive charges;
the distance between the target object and the TOF, i.e. the lighting distance of the outdoor lamp and the target object, is obtained by calculating respective charges stored in the capacitors C1 and C2.

Further optimizing the present technical solution, in said pulse modulation scheme, the speed of light is set as C, tₚ is the duration of the optical pulse, Q₁ denoting the amount of charges collected by the C1 capacitor, Q₂ denoting the amount of charges collected by the C2 capacitor, and ta denoting the time of flight of the optical pulse from being emitted, reflected, to being received, and then the formula for the distance d is shown below:

$${t}_{d} = {t}_{P} \times \frac{{Q}_{2}}{{Q}_{1 +} {Q}_{2}} ;$$

$$d = \frac{c \times {t}_{d}}{2} ;$$

due to the short duration of a single optical pulse, the emitting and receiving process described above is repeated thousands of times within a single frame of measurement time until the exposure time is reached, the charges received by different capacitors are integrated, and then the flight time of pulse is calculated to obtain the target distance.

Further optimizing the present technical solution, a minimum measurable distance dₘᵢₙ as well as a maximum measurable distance dₘₐₓ is defined in the pulse modulation scheme;

minimum measurable distance dₘᵢₙ: the object is very close, the light pulse is fast from emission to being reflected and received, and the capacitor C1 collects all the charges in the earlier sampling period, while the capacitor C2 does not collect the charges in the delayed sampling period, i.e. E₂=0, and dₘᵢₙ=0 is obtained by substituting into the formula for calculation of the distance d;

maximum measurable distance dₘₐₓ: the object is so far away that the light pulse has not been emitted to the detector in the earlier sampling period, i.e., the capacitor C2 collects all the charge and no charge is collected in the capacitor C1, and the maximum measurable distance dₘₐₓ is determined by width of the light pulse.

Further optimizing the present technical solution, in said step S4, the lamp is automatically turned off or dimmed, for example, when the distance of the target object is less than a specific value, such as 5 cm;
a suitable threshold is determined through experimentation to ensure that the lamp responds in a timely manner when it is close to a flammable object to avoid a fire, and at the same time, to avoid triggering it mistakenly during normal use based on the user's experience of using the lamp.

Further optimizing the present technical solution, in said step S5, when the target object is close to the lamp, the light gradually decreases, and vice versa, it is enhanced, and the mapping relationship between the brightness of the lamp and the distance is realized through programming to ensure that the light adjustment is smooth and natural, and to avoid abrupt brightness changes.

Further optimizing the present technical solution, in said step S6, among the multiple working modes:
in the sensing mode, the lamp automatically adjusts the brightness according to the distance of the target object;
in the constant brightness mode, the lamp always maintains the set brightness;
in the timer mode, the user sets the lamp to automatically turn on or off during a specific time period.

Further optimizing the present technical solution, in said step S7, the test includes high temperature, low temperature, humidity change, and strong light exposure test to assess the performance of the lamp under extreme conditions, and at the same time, the test ensures the sensitivity of the TOF sensor under different light conditions to ensure that it works stably and to avoid false triggering or malfunctioning of the lamp due to the environmental changes.

Compared with the prior art, the invention provides an outdoor lamp application method based on TOF technology, and has the following advantages:
the outdoor lamp application method based on TOF technology not only improves the responsiveness of the lamps under different environmental conditions through precise distance measurement and intelligent control, but also effectively prevents fire and other safety hazards. At the same time, the technology can realize the dynamic adjustment of lights, automatically adjusting the brightness according to the distance of the target object, thus improving the user experience, solving the problem that the application solution of the phototriode principle can not make a judgment on the black objects, and application of infrared emission principle is greatly affected by ambient light and the light source itself, not being able to make judgment; it can adapt to various application scenarios and promote the development of intelligent lighting equipment in the direction of more efficient, safe and intelligent.

### 4. BRIEF DESCRIPTION OF ACCOMPANY DRAWINGS

FIG. 1 is a flow chart of an outdoor lamp application method based on TOF technology provided by the invention;

FIG. 2 is a schematic diagram of a pulse modulation method for distance measurement in an outdoor lamp application method based on TOF technology provided by the invention;

FIG. 3 is a schematic diagram of a TOF distance measurement method in an outdoor lamp application method based on TOF technology provided by the invention;

FIG. 4 is a schematic diagram of a pulse modulation digital circuit provided by the invention.

### 5. SPECIFIC EMBODIMENT OF THE INVENTION

The technical scheme of the invention is further described clearly and detailedly hereinafter with reference to the drawings. Obviously, only partial embodiments of the invention are shown and the actual structure is not limited thereto. All other embodiments, which can be obtained by those skilled in the art without making any creative effort based on the embodiments in the present invention, shall all fall within the protective scope of the invention.

### EMBODIMENT

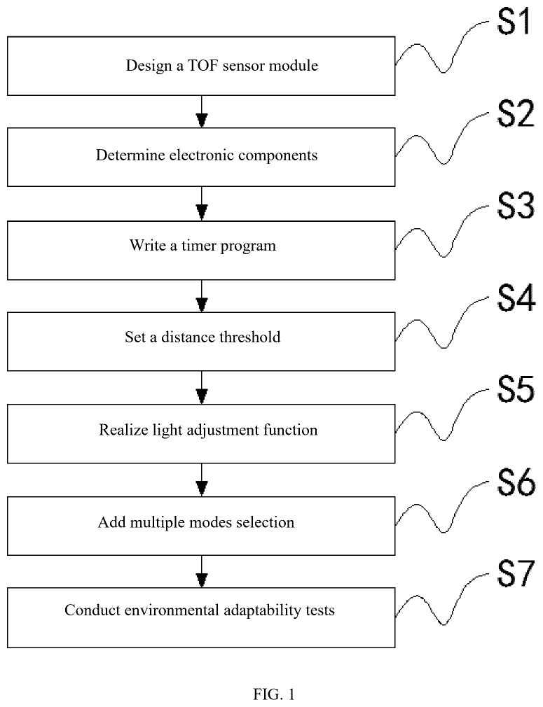

With reference to FIG. 1, an outdoor lamp application method based on TOF technology, comprising the following steps:

### S1 Design a TOF Sensor Module

selecting a TOF sensor module suitable for an outdoor environment, the module comprising an emitter and a detector to ensure that reflected signals can be accurately received under various lighting conditions, such as strong sunlight or at night.

In the embodiment, the emitter in the TOF sensor module is responsible for emitting pulsed light of a specific frequency, while the receiver is used to receive the pulsed light reflected back.

The TOF sensor module is designed to be well waterproof and shock-resistant for adapting to the harsh conditions of the outdoor environment.

### S2 Determine Electronic Components

After selecting the sensor, determine other electronic components required, such as microcontroller (MCU), timer, and lighting drive circuit.

In the embodiment, power management is also a key factor, which should ensure that the lamp can work stably in different environments, for example, choosing an efficient battery. A power management circuit needs to be designed to effectively extend the operating time of the lamp and ensure that the power supply is stable to the sensors and lamp.

### S3 Write a Timer Program

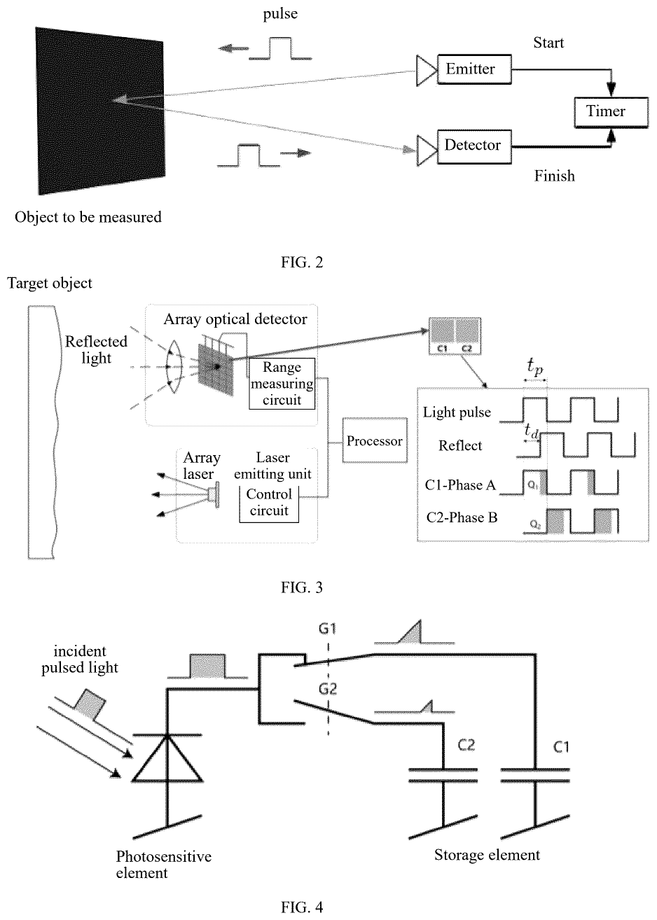

As shown in FIG. 2, using a timer function in the microcontroller, write a program to control pulse emission and reception of the TOF sensor module, after the transmitter sends out a pulse, the program needs to start the timer to record the time of pulse emission, and the timer stops when the detector receives a return pulse, at this time, distance of a target object is deduced by calculating the time difference, i.e. the round-trip time of the pulse, which is the lighting distance of the outdoor lamp and the target object.

In the embodiment, square wave pulse is used to construct the pulse modulation scheme based on the pulse modulation method of the square wave pulse by directly calculating the time difference between the pulse transmission and reception through a timer, and then finding the distance of the target object.

As shown in FIG. 3 and FIG. 4, further, constructing the pulse modulation scheme based on the pulse modulation method of square wave pulse comprises the following process:
a square wave modulated irradiated light source is used to realize pulse modulation in a digital circuit, the detector adopts an array optical detector, and the emitter adopts an array laser;
each pixel of the array optical detector consists of a unit that converts an incident light into a current-sensitive light, connected to 2 switches controlled by a mediation module, the switches are designed as G0 and G1, which introduce the current into different capacitors storing charges, the capacitors are designed as C1 and C2;
in the process of distance measurement, when the array laser emits optical pulses at the same time, a high-frequency switch is tuned to G1, a photosensitive element is connected to the C1 capacitor, generating a pulse window in phase A, and the C1 capacitor begins to receive charges;
after an optical pulse is emitted, the switch is tuned to G0, the photosensitive element is connected to the C2 capacitor, and generating another pulse window in delayed phase B, and the C2 capacitor begins to receive charges;
the distance between the target object and the TOF, i.e. the lighting distance of the outdoor lamp and the target object, is obtained by calculating respective charges stored in the capacitors C1 and C2.

In said pulse modulation scheme, the speed of light is set as C, tₚ is the duration of the optical pulse, Q₁ denoting the amount of charges collected by the C1 capacitor, Q₂ denoting the amount of charges collected by the C2 capacitor, and ta denoting the time of flight of the optical pulse from being emitted, reflected, to being received, and then the formula for the distance d is shown below:

$${t}_{d} = {t}_{P} \times \frac{{Q}_{2}}{{Q}_{1 +} {Q}_{2}} ;$$

$$d = \frac{c \times {t}_{d}}{2} ;$$

due to the short duration of a single optical pulse, the emitting and receiving process described above is repeated thousands of times within a single frame of measurement time until the exposure time is reached, the charges received by different capacitors are integrated, and then the flight time of pulse is calculated to obtain the target distance.

A minimum measurable distance dₘᵢₙ as well as a maximum measurable distance dₘₐₓ is defined in the pulse modulation scheme;
minimum measurable distance dₘᵢₙ: the object is very close, the light pulse is fast from emission to being reflected and received, and the capacitor C1 collects all the charges in the earlier sampling period, while the capacitor C2 does not collect the charges in the delayed sampling period, i.e. E₂=0, and dₘᵢₙ=0 is obtained by substituting into the formula for calculation of the distance d;
maximum measurable distance dₘₐₓ: the object is so far away that the light pulse has not been emitted to the detector in the earlier sampling period, i.e., the capacitor C2 collects all the charge and no charge is collected in the capacitor C1, and the maximum measurable distance dₘₐₓ is determined by width of the light pulse.

### S4 Set a Distance Threshold

According to different application scenarios of the lamps, different distance thresholds are set, which are used to realize automatic control of the lamps;

In the embodiment, the lamp is automatically turned off or dimmed, for example, when the distance of the target object is less than a specific value, such as 5 cm;
a suitable threshold is determined through experimentation to ensure that the lamp responds in a timely manner when it is close to a flammable object to avoid a fire, and at the same time, to avoid triggering it mistakenly during normal use based on the user's experience of using the lamp.

### S5 Realize Light Adjustment Function

Implement the light intensity adjustment function in the program, and control the brightness of the lamp through PWM (pulse width modulation) technology.

In the embodiment, when the target object is close to the lamp, the light gradually decreases, and vice versa, it is enhanced, and the mapping relationship between the brightness of the lamp and the distance is realized through programming to ensure that the light adjustment is smooth and natural, and to avoid abrupt brightness changes.

### S6 Add Multiple Modes Selection

Design a variety of working modes for the lamp, such as constant light mode, sensing mode and timer mode, and the user selects the appropriate working mode according to different scenes.

In the embodiment, among the multiple working modes:
in the sensing mode, the lamp automatically adjusts the brightness according to the distance of the target object;
in the constant brightness mode, the lamp always maintains the set brightness;
in the timer mode, the user sets the lamp to automatically turn on or off during a specific time period.

### S7 Conduct Environmental Adaptability Tests

Ensure that the lamp can work properly in various environments, and conduct a series of environmental adaptability tests.

In the embodiment, the test includes high temperature, low temperature, humidity change, and strong light exposure test to assess the performance of the lamp under extreme conditions, and at the same time, the test ensures the sensitivity of the TOF sensor under different light conditions to ensure that it works stably and to avoid false triggering or malfunctioning of the lamp due to the environmental changes.

After completing the initial design, the circuit is optimized to improve the efficiency and stability of the entire system. A more efficient LED drive circuit can be considered to reduce power consumption and increase battery life. At the same time, the circuit board is reasonably arranged to reduce interference and noise and ensure the accuracy of the TOF sensor module. Optimization of the circuit not only improves the performance of the lamps, but also reduces production costs and improves market competitiveness.

Establish a perfect after-sales service system to ensure that users can get timely help and support when they encounter problems during use. This includes providing detailed instruction manuals, setting up an online support platform, and regular product maintenance and update services. Continuously improve the functions and performance of the lamps by collecting feedback from users to ensure that the products can meet the needs of users in a long-term and stable manner and solve problems that cannot be overcome by traditional lamp technology.

The invention has the following advantages:
the outdoor lamp application method based on TOF technology not only improves the responsiveness of the lamps under different environmental conditions through precise distance measurement and intelligent control, but also effectively prevents fire and other safety hazards. At the same time, the technology can realize the dynamic adjustment of lights, automatically adjusting the brightness according to the distance of the target object, thus improving the user experience, solving the problem that the application solution of the phototriode principle can not make a judgment on the black objects, and application of infrared emission principle is greatly affected by ambient light and the light source itself, not being able to make judgment; it can adapt to various application scenarios and promote the development of intelligent lighting equipment in the direction of more efficient, safe and intelligent.

In the description of this specification, reference to the terms “an embodiment”, “some embodiments”, “examples”, “specific examples”, or “some examples” means that the specific features, structures, materials, or characteristics described in conjunction with the embodiment or example are included in at least one embodiment or example of the present invention. In this specification, schematic expressions of the above terms need not be directed to the same embodiment or example. Moreover, the specific features, structures, materials or characteristics described may be combined in a suitable manner in any one or more embodiments or examples. Moreover, without contradicting each other, those skilled in the art may combine and combine different embodiments or examples and features of different embodiments or examples described in this specification.

Although embodiments of the invention have been shown and described, it will be understood to those skilled in the art that a wide variety of changes, modifications, substitutions, and variations may be made to these embodiments without departing from the principle and spirit of the invention, the scope of which is limited by the appended claims and their equivalents.

1. An outdoor lamp application method based on TOF technology, comprising the following steps:
S1 design a TOF sensor module;
selecting a TOF sensor module suitable for an outdoor environment, the module comprising an emitter and a detector to ensure that reflected signals can be accurately received under various lighting conditions, such as strong sunlight or at night;
S2 determine electronic components;
after selecting the sensor, determine other electronic components required, such as microcontroller (MCU), timer, and lighting drive circuit;
S3 write a timer program;
using a timer function in the microcontroller, write a program to control pulse emission and reception of the TOF sensor module, after the transmitter sends out a pulse, the program needs to start the timer to record the time of pulse emission, and the timer stops when the detector receives a return pulse, at this time, distance of a target object is deduced by calculating the time difference, i.e. the round-trip time of the pulse, which is the lighting distance of the outdoor lamp and the target object;
S4 set a distance threshold;
according to different application scenarios of the lamps, different distance thresholds are set, which are used to realize automatic control of the lamps;
S5 realize light adjustment function;
implement the light intensity adjustment function in the program, and control the brightness of the lamp through PWM (pulse width modulation) technology;
S6 add multiple modes selection;
design a variety of working modes for the lamp, such as constant light mode, sensing mode and timer mode, and the user selects the appropriate working mode according to different scenes;
S7 conduct environmental adaptability tests;
ensure that the lamp can work properly in various environments, and conduct a series of environmental adaptability tests.

2. The outdoor lamp application method based on TOF technology of claim 1, wherein in said step S1, the emitter in the TOF sensor module is responsible for emitting pulsed light of a specific frequency, while the receiver is used to receive the pulsed light reflected back;
the TOF sensor module is designed to be well waterproof and shock-resistant for adapting to the harsh conditions of the outdoor environment.

3. The outdoor lamp application method based on TOF technology of claim 1, wherein in said step S3, square wave pulse is used to construct the pulse modulation scheme based on the pulse modulation method of the square wave pulse by directly calculating the time difference between the pulse transmission and reception through a timer, and then finding the distance of the target object.

4. The outdoor lamp application method based on TOF technology of claim 3, wherein in said step S3, constructing the pulse modulation scheme based on the pulse modulation method of square wave pulse comprises the following process:
a square wave modulated irradiated light source is used to realize pulse modulation in a digital circuit, the detector adopts an array optical detector, and the emitter adopts an array laser;
each pixel of the array optical detector consists of a unit that converts an incident light into a current-sensitive light, connected to 2 switches controlled by a mediation module, the switches are designed as G0 and G1, which introduce the current into different capacitors storing charges, the capacitors are designed as C1 and C2;
in the process of distance measurement, when the array laser emits optical pulses at the same time, a high-frequency switch is tuned to G1, a photosensitive element is connected to the C1 capacitor, generating a pulse window in phase A, and the C1 capacitor begins to receive charges;
after an optical pulse is emitted, the switch is tuned to G0, the photosensitive element is connected to the C2 capacitor, and generating another pulse window in delayed phase B, and the C2 capacitor begins to receive charges;
the distance between the target object and the TOF, i.e. the lighting distance of the outdoor lamp and the target object, is obtained by calculating respective charges stored in the capacitors C1 and C2.

5. The outdoor lamp application method based on TOF technology of claim 4, wherein in said pulse modulation scheme, the speed of light is set as C, tₚ is the duration of the optical pulse, Q₁ denoting the amount of charges collected by the C1 capacitor, Q₂ denoting the amount of charges collected by the C2 capacitor, and t_{d} denoting the time of flight of the optical pulse from being emitted, reflected, to being received, and then the formula for the distance d is shown below:
$${t}_{d} = {t}_{P} \times \frac{{Q}_{2}}{{Q}_{1 +} {Q}_{2}} ;$$
$$d = \frac{c \times {t}_{d}}{2} ;$$
due to the short duration of a single optical pulse, the emitting and receiving process described above is repeated thousands of times within a single frame of measurement time until the exposure time is reached, the charges received by different capacitors are integrated, and then the flight time of pulse is calculated to obtain the target distance.

6. The outdoor lamp application method based on TOF technology of claim 4, wherein a minimum measurable distance dₘᵢₙ as well as a maximum measurable distance dₘₐₓ is defined in the pulse modulation scheme;
minimum measurable distance dₘᵢₙ: the object is very close, the light pulse is fast from emission to being reflected and received, and the capacitor C1 collects all the charges in the earlier sampling period, while the capacitor C2 does not collect the charges in the delayed sampling period, i.e. E₂=0, and dₘᵢₙ=0 is obtained by substituting into the formula for calculation of the distance d;
maximum measurable distance dₘₐₓ: the object is so far away that the light pulse has not been emitted to the detector in the earlier sampling period, i.e., the capacitor C2 collects all the charge and no charge is collected in the capacitor C1, and the maximum measurable distance dₘₐₓ is determined by width of the light pulse.

7. The outdoor lamp application method based on TOF technology of claim 1, wherein in said step S4, the lamp is automatically turned off or dimmed, for example, when the distance of the target object is less than a specific value, such as 5 cm;
a suitable threshold is determined through experimentation to ensure that the lamp responds in a timely manner when it is close to a flammable object to avoid a fire, and at the same time, to avoid triggering it mistakenly during normal use based on the user's experience of using the lamp.

8. The outdoor lamp application method based on TOF technology of claim 1, wherein in said step S5, when the target object is close to the lamp, the light gradually decreases, and vice versa, it is enhanced, and the mapping relationship between the brightness of the lamp and the distance is realized through programming to ensure that the light adjustment is smooth and natural, and to avoid abrupt brightness changes.

9. The outdoor lamp application method based on TOF technology of claim 1, wherein in said step S6, among the multiple working modes:
in the sensing mode, the lamp automatically adjusts the brightness according to the distance of the target object;
in the constant brightness mode, the lamp always maintains the set brightness;
in the timer mode, the user sets the lamp to automatically turn on or off during a specific time period.

10. The outdoor lamp application method based on TOF technology of claim 1, wherein in said step S7, the test includes high temperature, low temperature, humidity change, and strong light exposure test to assess the performance of the lamp under extreme conditions, and at the same time, the test ensures the sensitivity of the TOF sensor under different light conditions to ensure that it works stably and to avoid false triggering or malfunctioning of the lamp due to the environmental changes.
